(19) United States
(12) Patent Application Publication
(10) Pub. No.: US 2007/0009294 A1
(43) Pub. Date: Jan. 11, 2007

(54) Toner for electrostatic latent image development and image forming method

(76) Inventor: Koji Kuramashi, Osaka (JP)

Correspondence Address: Arthur G. Schaier;Carmody & Torrance LLP, P.O. Box 1110, 50 Leavenworth Street, Waterbury, CT, 06721-1110, US

(21) Appl. No.: 11/453,473

(22) Filed: Jun. 15, 2006

(30) Foreign Application Priority Data
Jun. 28, 2005 (JP) 2005-187877

(51) Int. Cl. G03G 21/00

(52) U.S. Cl. 399/356

(57) ABSTRACT

The present invention provides a toner for a electrostatic latent image development and an image forming method which could print an image having the high quality for a long time period by forming a thin toner layer having a uniform thickness on a developing sleeve and, at the same time, by maintaining a surface of a photoconductor in the clean conditions irrespective of a change brought about by a lapse of time or an environmental change. In a toner for electrostatic latent image development which is used for an image forming apparatus comprising an electrophotographic photoconductor and a developing sleeve which is arranged close to the electrophotographic photoconductor, the toner is externally added with at least silica and titanium oxide to toner particles containing a magnetic powder, wherein assuming Si strength of the toner as I_{Si}, Ti strength of the toner as I_{Ti} and Fe strength of the toner as I_{Fe} when these strengths are measured by using a fluorescent X-ray analyzing device, the following relationships (1) and (2) are satisfied.
9.0×10⁻³≦I_{Si}/I_{Fe}≦1.0×10⁻² (1)
6.0×10⁻³≦I_{Ti}/I_{Fe}≦8.0×10⁻³ (2)

### TECHNICAL FIELD

The present invention relates to a toner for electrostatic latent image development which is used in an image forming apparatus such as a copying machine, a printer, a facsimile or a composite machine thereof which uses an electrophotographic method, and an image forming method which uses the toner for electrostatic latent image development.

In general, a developing method adopted by an image forming apparatus such as a copying machine, a printer, a facsimile, a composite machine thereof or the like which uses an electrophotographic method is classified into a monocomponent developing method which uses a monocomponent developer and a two-component developing method which uses a two-component developer.

However, since the two-component developing method uses a carrier and requires a mechanism which controls a mixing ratio of toner and carrier, the downsizing and the reduction of weight of the image forming apparatus are difficult. Accordingly, the monocomponent developing method is considered suitable to cope with a demand for the miniaturization, the reduction of weight and the low power consumption along with the recent personalization of the image forming apparatus.

Here, among the monocomponent developing methods, particularly, a magnetic jumping method is capable of generating sufficient triboelectric charging by increasing a chance which brings the developing sleeve and the toner into contact with each other thus preventing the aggregation of toner particles and realizing the acquisition of an excellent image.

However, as a first drawback of the magnetic jumping method, there exists the drawback that when the developing method is used under high moisture, a toner charging quantity on the developing sleeve is lowered and, as a result, a defect relating to an image such as thin density occurs.

Here, to overcome the above-mentioned drawback, there has been proposed a toner which could enhance the environmental stability such as resistance against the high moisture by adjusting magnetic physical property of magnetic powder in toner particles (for example, see patent document 1).

Further, as a second drawback of the magnetic jumping method, there exists the drawback that when an amorphous silicon photoconductor having the substantially equal lifetime as an image forming apparatus is used, the moisture, the products formed by discharging such as ozone or NOx, a toner resin, a wax and the like are adhered to a photoconductor and hence, it is necessary to remove such adherents.

In view of such circumstances, to overcome the above-mentioned drawbacks, there has been proposed a method which cleans an amorphous silicon photoconductor by using a cleaning roller having a grinding agent (for example, see patent document 2).

[Patent document 1] JP8-50369A

[Patent document 2] JP10-111629A

### DISCLOSURE OF THE INVENTION

### Problems to be Solved by the Invention

However, in an attempt to overcome the first drawback by using a method such as the method disclosed in the patent document 1, when the printing is repeatedly performed for a long time period, when the printing is performed under the low moisture condition or when a peripheral speed of a developing sleeve is increased for realizing high speed printing, it is difficult to allow a thin toner layer formed on the developing sleeve to have a uniform thickness.

Further, in an attempt to overcome the second drawback by using a method such as the method disclosed in patent document 2, when the printing is repeatedly performed for a long time period, a grinding force of the cleaning roller is lowered and it is difficult to provide an image having a high quality.

Here, the inventors of the present invention have found out that, by using a toner for electrostatic latent image development in which Si strength, Ti strength and Fe strength of the toner when these strengths are measured by using the fluorescent X-ray analyzing device satisfy a predetermined relationship, and which has a predetermined average degree of circularity, and by using a developing sleeve having a predetermined surface average gradient (Δa), it may be possible to effectively prevent a defective image which occurs due to the contamination of a surface of a photoconductor or a defective image which occurs attributed to the irregularity of a thickness of the thin toner layer on the sleeve. The inventors of the present invention have accomplished the present invention based on such findings.

That is, it is an object of the present inventions to provide a toner for electrostatic latent image development and an image forming apparatus which can form a thin toner layer having a uniform thickness on a developing sleeve irrespective of a change brought about by a lapse of time or an environmental change and, at the same time, can print an image having a high quality for a long time period by maintaining a surface of a photoconductor in the clean conditions.

### MEANS FOR SOLVING THE PROBLEM

The present invention is directed to a toner for electrostatic latent image development which is used for an image forming apparatus including an electrophotographic photoconductor and a developing sleeve which is arranged close to the electrophotographic photoconductor, the toner being externally added with at least silica and titanium oxide to toner particles containing magnetic powder, wherein assuming Si strength of the toner as I_{Si}, Ti strength of the toner as I_{Ti} and Fe strength of the toner as I_{Fe} when these strengths are measured by using a fluorescent X-ray analyzing device, the following relationships (1) and (2) are satisfied, an average degree of circularity of the toner particles is set to a value which falls within a range from 0.940 to 0.960, and a surface average gradient of the developing sleeve (Δa) is set to a value which falls within a range from 0.1 to 0.25 rad and hence, it may be possible to overcome the above-mentioned drawback.
9.0×10⁻³≦I_{Si}/I_{Fe}≦1.0×10⁻² (1)
6.0×10⁻³≦I_{Ti}/I_{Fe}≦8.0×10⁻³ (2)

That is, by using the toner for electrostatic latent image development in which the Si strength (I_{Si}), the Ti strength (I_{Ti}) and the Fe strength (I_{Fe}) of the toner when the strengths are measured by using the fluorescent X-ray analyzing device satisfy the predetermined relationships, it may be possible to form and maintain the thin toner layer having a uniform thickness on the developing sleeve irrespective of a change brought about by a lapse of time or an environmental change and maintain the photoconductor surface in the clean conditions. Accordingly, it may be possible to form images having a high quality for a long time period.

Further, by using toner particles having the average degree of circularity which falls within a predetermined range, irrespective of a change brought about by a lapse of time or an environmental change, it may be possible to form and maintain the thin toner layer having a further uniform thickness on the developing sleeve.

Further, by setting the surface average gradient (Δa) of the developing sleeve to the value which falls within a predetermined range, in view of the relationship between the surface average gradient (Δa) and the toner particles having an average degree of circularity which falls within a predetermined range, irrespective of a change brought about by a lapse of time or an environmental change, it may be possible to form and maintain the thin toner layer having a further uniform thickness on the developing sleeve.

Here, the surface average gradient (Δa) is defined as an average value of absolute values of respective segments (angles) each of which connects a beginning point and an end point of the measurement curve in each segment when a measurement curve is divided into segments in a given direction (ΔX) in the lateral direction.

Further, in forming the toner for electrostatic latent image development according to the present invention, it may be preferable to set a content of the magnetic powder to a value which falls within a range from 30 to 50 weight % with respect to a total quantity of the toner particles.

Due to such a constitution, in measuring the strengths by using a fluorescent X-ray analyzing device, the adjustment of the Fe strength (I_{Fe}) is particularly facilitated. Further, along with the facilitation of the above-mentioned adjustment of the Fe strength (I_{Fe}), the adjustment of the Si strength (I_{Si}) and adjustment of the Ti strength (I_{Ti}) are also respectively facilitated and hence, the toner may be possible to easily satisfy the relationships (1) and (2).

Further, in forming the toner for electrostatic latent image development of the present invention, it may be preferable that a portion of the magnetic powder is exposed on the surface of the toner particles.

Due to such a constitution, the adjustment of ranges of relationships (1) and (2) and the adjustment of average degree of circularity of the toner particles are further facilitated and hence, it may be possible to form and maintain the thin toner layer having a further uniform thickness on the developing sleeve.

Further, in forming the toner for electrostatic latent image development of the present invention, it may be preferable to set a ten-point average roughness (Rz) of the developing sleeve which is measured in accordance with JIS B0601 to a value which falls within a range from 3.5 to 5.0 μm.

Due to such a constitution, irrespective of a change brought about by a lapse of time or an environmental change, it may be possible to form and maintain the thin toner layer having a further uniform thickness on the developing sleeve.

Further, in forming the toner for electrostatic latent image development of the present invention, it may be preferable to set an average interval (Sm) of the developing sleeve which is measured in accordance with JIS B0601 to a value which falls within a range from 50 to 70 μm.

Due to such a constitution, irrespective of a change brought about by a lapse of time or an environmental change, it may be possible to form and maintain the thin toner layer having a further uniform thickness on the developing sleeve.

Further, in forming the toner for electrostatic latent image development of the present invention, it may be preferable to set a volume average particle size of the toner particles to a value which falls within a range from 3 to 20 μm.

Due to such a constitution, in either one of a color toner or a black toner, irrespective of a change brought about by a lapse of time or an environmental change, it may be possible to form and maintain the thin toner layer having a further uniform thickness on the developing sleeve.

Further, in forming the toner for electrostatic latent image development of the present invention, it may be preferable that the photoconductor is an amorphous silicon photoconductor.

Due to such a constitution, it may be possible to maintain the surface of the photoconductor in the further clean conditions and to form images having a high quality for a long time period.

Further, another aspect of the present invention is directed to an image forming method which is characterized by using any one of the above-mentioned toners for electrostatic latent image development.

That is, in the image forming method which uses a toner for electrostatic latent image development which is externally added with at least silica and titanium oxide to the toner particles containing a magnetic powder is applied to a magnetic jumping method which uses an electrophotographic photoconductor and a developing sleeve arranged close to the electrophotographic photoconductor, wherein as the toner for electrostatic latent image development, a toner for electrostatic latent image development which satisfies the following relationships (1) and (2) and sets Si strength of the toner as I_{Si}, Ti strength of the toner as I_{Ti} and Fe strength of the toner as I_{Fe} when these strengths are measured by using a fluorescent X-ray analyzing device, and sets an average degree of circularity of the toner particles to a value which falls within a range from 0.940 to 0.960 and a surface average gradient (Δa) to a value which falls within a range from 0.1 to 0.25 rad is used.
9.0×10⁻³≦I_{Si}/I_{Fe}≦1.0×10⁻² (1)
6.0×10⁻³≦I_{Ti}/I_{Fe}≦8.0×10⁻³ (2)

That is, by using the toner for electrostatic latent image development in which the Si strength (I_{Si}), the Ti strength (I_{Ti}) and the Fe strength (I_{Fe}) satisfy the predetermined relationships when these strengths are measured by using the fluorescent X-ray analyzing device, irrespective of a change brought about by a lapse of time or an environmental change, it may be possible to form and maintain the thin toner layer having a uniform thickness on the developing sleeve and, at the same time, to maintain the surface of the photoconductor in the clean conditions. Accordingly, it may be possible to form images having a high quality for a long time period.

Further, by using the toner particles having the average degree of circularity which falls within the predetermined range, irrespective of a change brought about by a lapse of time or an environmental change, it may be possible to form and maintain the thin toner layer having a further uniform thickness on the developing sleeve.

Further, by setting the surface average gradient (Δa) of the developing sleeve to a value within the predetermined range, in view of the relationship between the surface average gradient (Δa) and the toner particles having an average degree of circularity which falls within a predetermined range, irrespective of a change brought about by a lapse of time or an environmental change, it may be possible to form and maintain the thin toner layer having a further uniform thickness on the developing sleeve.

Here, in the image forming method according to the present invention, even when the magnetic jumping method is used, it may be possible to maintain the thin toner layer on the developing sleeve uniformly, and even when the printing is repeated for a long time period, it may be possible to provide images having a high quality.

### BRIEF EXPLANATION OF THE DRAWINGS

FIG. 1 is a view showing a relationship between a fluorescent X-ray intensity ratio (I_{Si}/I_{Fe}) and the fogging density (relative value) of the toner.

FIG. 2 is a view showing a relationship between the fluorescent X-ray intensity ratio (I_{Si}/I_{Fe}) and a thin layer irregularities evaluation (relative value) of the toner.

FIG. 3 is a view showing a relationship between a fluorescent X-ray intensity ratio (I_{Ti}/I_{Fe}) and a residual toner adhesion to a drum evaluation (relative value) of the toner.

FIG. 4 is a view showing a relationship between the fluorescent X-ray intensity ratio (I_{Ti}/I_{Fe}) and the image density evaluation (relative value) of the toner.

FIG. 5 is a schematic view showing a developing unit.

FIG. 6 is a view which serves to explain an image forming apparatus.

### BEST MODE FOR CARRYING OUT THE INVENTION

Hereinafter, embodiments on a toner for electrostatic latent image development according to the present invention and an image forming method which uses the toner for electrostatic latent image development are specifically explained in conjunction with drawings.

### First Embodiment

A first embodiment is directed to a toner for electrostatic latent image development which is used for an image forming apparatus including an electrophotographic photoconductor and a developing sleeve which is arranged close to the electrophotographic photoconductor, the toner being externally added with at least silica and titanium oxide to toner particles containing a magnetic powder, wherein assuming Si strength of the toner as I_{Si}, Ti strength of the toner as I_{Ti} and Fe strength of the toner as I_{Fe} when these strengths are measured by using a fluorescent X-ray analyzing device, the following relationships (1) and (2) are satisfied, an average degree of circularity of the toner particles is set to a value which falls within a range from 0.940 to 0.960, and a surface average gradient of the developing sleeve (Δa) is set to a value which falls within a range from 0.1 to 0.25 rad.
9.0×10⁻³≦I_{Si}/I_{Fe}≦1.0×10⁻² (1)
6.0×10⁻³≦I_{Ti}/I_{Fe}≦8.0×10⁻³ (2)
1. Toner Particles
(1) Basic Constitution

The toner particles which are used in the first embodiment are preferably basically constituted of a binder resin, a magnetic powder, a wax group, a coloring agent and a charge control agent.

(2) Binder Resin

Although a kind of the binder resin which is used for toner particles is not particularly limited, it may be preferable to use a thermoplastic resin such as, for example, a styrene resin, an acrylic resin, a styrene-acrylic copolymer, a polyethylene resin, a polypropylene resin, a vinyl chloride resin, a polyester resin, a polyamide resin, a polyurethane resin, a polyvinyl alcohol resin, a vinyl ether resin, a N-vinyl resin, a styrene-butadiene resin etc.

Further, in the binder resin, it may be preferable that the binder resin contains a plurality of binder resins and, at the same time, a first binder resin in which a weight average molecular weight peak is set to a value which falls within a range from 1.0×10⁴ to 5.0×10⁴, and a second binder resin in which a weight average molecular weight peak is set to a value which falls within a range from 1.0×10⁶ to 5.0×10⁶, for example. That is, in the molecule weight distribution of the binder resin, it may be preferable that the binder resin has two molecular weight peaks (sometimes referred to as a low molecular weight peak and a high molecular weight peak).

The reason is that when these two molecular weight peaks are respectively set to values which fall within the predetermined ranges, it may be possible to obtain an excellent fixing property, while a heat resistance becomes favorable and hence, in the image forming apparatus which uses a magnetic jumping system, even when the printing is sequentially carried out at a high temperature and under a high moisture, it may be possible to effectively prevent drawbacks such as toner aggregation due to temperature elevation of the machine and the developing unit or the like.

Accordingly, it may be preferable to set the low molecular weight peak to a value which falls within a range from 2.0×10⁴ to 4.0×10⁴ and to set the high molecular weight peak to a value which falls within a range from 2.0×10⁶ to 4.0×10⁶.

Here, it may be preferable to set an addition quantity of the binder resin to a value which falls within a range from 45 to 65 weight % with respect to a total quantity of the toner particles.

The reason is that, when the addition quantity of the binder resin is less than 45 weight %, there may arise a case in which the obtained toners are melted with each other and the preservation stability is lowered, while when the addition quantity of the binder resin exceeds 65 weight %, there may arise a case in which the fixing property of the toner is lowered.

Accordingly, it may be preferable to set the addition quantity of the binder resin to a value which falls within a range from 45 to 65 weight % with respect to the total quantity of the toner particles.

(3) Magnetic Powder

Further, the toner may be formed into a magnetic toner by dispersing a known magnetic powder into the toner.

As such a magnetic powder, a metal powder or an alloy powder which exhibits ferromagnetism such as a ferrite powder, a magnetite powder, an iron powder, a cobalt powder, a nickel powder or a compound powder which contains the ferromagnetic elements can be named.

Further, it may be preferable to set an average particle size of the magnetic powder to a value which falls within a range from 0.1 to 1 μm and, it is more preferable to set the average particle size to a value which falls within a range from 0.1 to 0.5 μm.

The reason is that the magnetic powder having the average particle size is easy to handle and it may be possible to uniformly disperse the magnetic powder into the binder resin in a fine powdery form without generating the aggregation of the magnetic powder.

Further, it may be preferable to apply surface treatment to the magnetic powder by using a surface treatment agent such as a titanium-based coupling agent or a silane-based coupling agent.

The reason is that, by carrying out the surface treatment in this manner, it may be possible to improve hygroscopic property of the magnetic powder and the dispersion property of the magnetic powder with respect to the binder resin.

Further, it may be preferable to set a content of the magnetic powder to a value which falls within a range from 30 to 50 weight % with respect to a total quantity of the toner particles.

The reason is that, due to such a constitution, the adjustment of the Fe strength (I_{Fe}), when the strengths are measured by using a fluorescent X-ray analyzing device, is particularly facilitated. Further, along with such facilitation of the adjustment of the Fe strength (I_{Fe}), the adjustment of the Si strength (I_{Si}) and the adjustment of the Ti strength (I_{Ti}) are also respectively facilitated and hence, it may be possible to easily satisfy the relationships. In other words, when the content of the magnetic powder is set to a value less than 30 weight % or more than 50 weight %, it is difficult to perform the respective adjustments of the Si strength (I_{Si}), the Ti strength (I_{Ti}) and the Fe strength (I_{Fe}) when these strengths are measured by using the fluorescent X-ray analyzing device and hence, it becomes further difficult to satisfy the relationships (1) and (2).

Accordingly, it may be preferable to set a content of the magnetic powder to a value which falls within a range from 33 to 48 weight % with respect to a total quantity of the toner particles, and it may be still more preferable to set the content of the magnetic powder to a value which falls within a range from 35 to 45 weight % with respect to a total quantity of the toner particles.

Further, it may be preferable that a portion of the magnetic powder is exposed on surfaces of the toner particles.

The reason is that, due to such a constitution, it may be possible to form and maintain the thin toner layer having a further uniform thickness on the developing sleeve.

That is, the magnetic powder which is exposed from the surfaces of the toner particles is directly brought into contact with the surface of the developing sleeve and hence, it may be possible to enhance the magnetic property between the developing sleeve and the toner particles.

On the other hand, by adjusting an exposing quantity of the magnetic powder on the surface of the developing sleeve, it may be possible to adjust the transfer efficiency of the magnetic powder from the developing sleeve to the photoconductor. Accordingly, assuming a total quantity of the magnetic powder which is dispersed in the toner as 100 weight %, it may be preferable to set a ratio of the magnetic powder which is exposed on the toner surface to a value which falls within a range from 20 to 80 weight % and, more preferably, to a value which falls within a range from 40 to 60 weight %.

(4) Wax

Further, although a kind of the wax which is used for the toner particles is not particularly limited, for example, one, two or more kinds of waxes selected from a group consisting of a polyethylene wax, a polypropylene wax, a fluororesin wax, a fischer tropsch wax, a paraffin wax, an ester wax, a montan wax, a rice wax and the like in a single form or in combination.

Further, although the addition quantity of the wax is not also particularly limited, for example, assuming the total quantity of the toner as 100 weight %, it may be preferable to set the addition quantity of the wax to a value which falls within a range from 0.1 to 20 weight %. The reason is that when the addition quantity of the wax is less than 1 weight %, there arises the tendency that an offset to a reading head, image smearing and the like could not be efficiently prevented, while when the addition quantity of the wax exceeds 5 weight %, the toner particles are melted together thus giving rise to a tendency in which the preservation stability is lowered. Accordingly, it may be preferable to set the addition quantity of the wax to a value which falls within a range from 1 to 10 weight %.

(5) Charge Control Agent

It may be preferable to add a charge control agent to the toner particles. The reason is that the addition of the charge control agent could remarkably enhance a charge level or the charge rise characteristic (an index to indicate whether the toner is charged to a fixed charge level in a short time) thus providing the excellent durability and stability.

Although a type of such a charge control agent is not specifically limited, it may be preferable to use the charge control agent which shows a positive charging property such as, nigrosine, a quaternary ammonium salt compound, a resin-type charge control agent in which an amine compound is combined with a resin or the like, for example.

Further, when the total quantity of the toner is set to 100 weight %, it may be preferable to set the addition quantity of the charge control agent to a value which falls within a range from 1.0 to 10 weight %. The reason is that when the addition quantity of the charge control agent is less than 1.0 weight %, it is difficult to apply the stable charge to the toner particles and hence, there may be cases in which the image density is lowered, so-called fogging occurs, or the durability is lowered, while when the addition quantity of the charge control agent exceeds 10 weight %, there may be a case that defects such as the poor environment resistance property, particularly the insufficient charge and the defective image under high temperature and high moisture, the contamination of a photoconductor or the like, are liable to be generated.

(6) Degree of Average Circularity

Further, the toner is characterized in that an average degree of circularity of the toner particles is set to a value which falls within a range from 0.940 to 0.960.

The reason is that, due to such a constitution, irrespective of a change brought about by a lapse of time or an environmental change, it may be possible to form and maintain the thin toner layer having a further uniform thickness on the developing sleeve.

That is, when the average degree of circularity of the toner particles is set to a value less than 0.940, the fluidity of the toner particles is lowered and hence, the toner may be aggregated in the course that the toner particles are conveyed from a developing container to the surface of the developing sleeve or the toner may be adhered to a surface of a toner conveying member or the like.

Further, another reason is that when such toner particles are continuously used for a long time period, the supply of the toner particles to the photoconductor becomes insufficient and hence, it is difficult to maintain the image density.

Still another reason is that, in such toner particles, stress generated between the toner particles is large and hence, the toner is easily aggregated in the inside of the developing unit thus giving rise to the drawback that stripes are formed on the developing sleeve.

On the other hand, when the average degree of circularity of the toner particles exceeds 0.960, the fluidity of the toner particles is improved and hence, it may be possible to easily maintain the image density. However, in such toner particles having the average degree of circularity of more than 0.960, there may arise the drawback that adjustment of charging becomes difficult. For example, in the developing unit which uses a metal material such as stainless steel or the like as a material of the sleeve, a charge imparting force of the sleeve is strong and hence, toners existing in the vicinity of the sleeve surface have an extremely high charge and hence, the toners are strongly attracted to the surface of the sleeve by a reflection force whereby an immobile layer may be easily formed. That is, when the average degree of circularity of the toner particles exceeds 0.960, a chance of friction between the toner particles and the sleeve is decreased and hence, the imparting of charge is interrupted. As a result, due to the non-uniform charging of the toner, the irregularities or “mura” on a thin toner layer which is formed on the developing sleeve are generated thus giving rise to a possibility that the thin layer irregularities are generated.

Accordingly, it may be preferable to set the average degree of circularity of the toner particles to a value which falls within a range from 0.945 to 0.955, and more preferably, within a range from 0.948 to 0.952.

Here, the average degree of circularity of the toner particles may be calculated by a method exemplified in the example 1 which will be described later.

Further, it may be preferable to set a content of the toner particles having an average degree of circularity less than 0.850 to a value which falls within a range from 2.0 to 4.0 unit % with respect to the total quantity of the toner particles. That is, this implies that the toner having an average degree of circularity less than 0.850 and slightly contains toner particles having shapes remote from a true spherical shape.

The reason is that, when the content of the toner having the average degree of circularity less than 0.850 exceeds 4.0 unit %, a contact area between the toner particles and the photoconductor is increased and hence, the adhesive force of the toner particles to the photoconductor is increased and hence, it may be impossible to obtain the sufficient transfer efficiency and to maintain the image density.

On the other hand, when the content of the toner having the average degree of circularity less than 0.850 becomes less than 2.0 unit %, the contact area between the toner particles and the photoconductor is small and hence, the adhesive force of the toner particles to the photoconductor is decreased and hence, it may be possible to obtain the sufficient transfer efficiency and to maintain the image density within a predetermined range. Further, the average degree of circularity of the toner particles is uniform and hence, in the above-mentioned developing unit, a stress due to a friction between the toner particles and the spiral member is small and the fluidity is not easily lowered.

Accordingly, in the present invention, it may be preferable to set the content of the toner particles having average degree of circularity less than 0.850 to a value which falls within a range from 2.0 to 4.0 unit % with respect to the total quantity of the toner particles.

2. Additive Agent

(1) Silica

Further, the toner according to the present invention is characterized in that, as an additive agent to the toner particles, silica is subjected to the externally adding treatment (hereinafter sometimes referred to as aggregated silica) to the toner particles.

Further, for the silica, it may be preferable to have a particle distribution such that a ratio of the silica having the particle size of 5 μm or less is set to a value equal to or less than 15% with respect to the total quantity of the silica, and a ratio of the silica having the particle size of 50 μm or more is set to a value equal to or less than 3% with respect to the total quantity of the silica.

The reason is that when the ratio of the silica having the particle size of 5 μm or less exceeds 15%, the silica is liable to be easily adhered to the photoconductor particles so that the silica is re-aggregated and, at the same time, the silica is gathered around the silica having relatively large particle sizes so that the layer irregularities are liable to be easily generated, while when the ratio of the silica having the particle size of 50 μm or more exceeds 3%, the silica having the relatively small particle sizes are gathered around the silica thus forming large aggregated silica whereby the layer irregularities are also liable to be easily generated.

Accordingly, as the more preferable particle distribution of such silica, the ratio of silica having the particle size of 5 μm or less is set to a value less than 10% with respect to the total quantity of the silica and, at the same time, the ratio of silica having the particle size of 50 μm or more is set to a value less than 2%.

Here, the particle distribution of aggregated silica can be measured by using a laser diffraction grating particle size measuring device LA-500 made by Horiba Seisakusho company LTD.

(2) Titanium Oxide

Further, the toner according to the present invention is characterized in that, as an additive agent to the toner particles, titanium oxide is subjected to the adding treatment to the toner particles.

Further, it may be preferable to set an average particle size of titanium oxide to a value which falls within a range from 0.01 to 0.50 μm.

The reason is that when the average particle size of titanium oxide is set to a value less than 0.01 μm, there may be a case that it is difficult for the toner to exhibit the uniform grinding effect and hence, the charge-up occurs or the image flow is generated under high temperature and high moisture condition thus leading to the occurrence of image defects. Still another reason is that, when the average particle size of titanium oxide exceeds 0.50 μm, the irregularities of the charge quantity in the toner are increased thus giving rise to a case in which the image density is lowered or the durability is lowered.

Accordingly, it may be preferable to set the average particle size of titanium oxide to a value which falls within a range from 0.02 to 0.4 μm, and it is more preferable to set the average particle size of titanium oxide to a value which falls within a range from 0.05 to 0.3 μm.

Here, it may be possible to measure the average particle size of titanium oxide by using an electron microscope and a picture analyzing device in combination. That is, by properly using the magnification ratio of 30,000 times to 100,000 times, by using the electron microscope JSM-880 (made by JEOL DATUM LTD.), long diameters and short diameters of 50 particles are respectively measured, by using the picture analyzing device, the average long diameter and the average short diameter are calculated.

Further, it may be preferable to apply a surface treatment to surfaces of titanium oxide with a titanate compound (containing a titan-based coupling agent).

The reason is that by applying such a surface treatment, it may be possible to easily introduce a hydrophobic group to the surfaces of titanium oxide. Accordingly, with the use of titanium oxide to which the surface treatment is applied, it may be possible to prevent the lowering of the charging properties of the toner under high temperature and high moisture conditions particularly.

Here, as a preferred titanate compound, one kind or the combination of two or more kinds of the titanate compound from a group consisting of isopropyl triisostearoyl titanium, vinyl trimethoxy titanium, naphthyl trimethoxy titanium, phenyl trimethoxy titanium, methyl trimethoxy titanium, ethyl trimethoxy titanium, propyl trimethoxy titanium, isobutyl trimethoxy titanium, octadecyl trimethoxy titanium and the like is named.

Further, it may be preferable to set an addition quantity of titanium oxide to a value which falls within a range from 0.5 to 2.5 parts by weight with respect to 100 parts by weight of the toner particles.

The reason is that when the addition quantity becomes less than 0.5 parts by weight, there may be a case that it is difficult to acquire the effective grinding effect and the charging property under the high-temperature and high-moisture condition is remarkably lowered. On the other hand, when the addition quantity exceeds 7 parts by weight, there may be a case that the charge-up is liable to be easily generated and the charging property under the low-temperature and low-moisture condition is remarkably increased locally.

Accordingly, it is more preferable to set the addition quantity of titanium oxide to a value which falls within a range from 1 to 2 parts by weight with respect to 100 parts by weight of toner particles. It is still more preferable to set the addition quantity of titanium oxide to a value which falls within a range from 1.2 to 1.6 parts by weight with respect to 100 parts by weight of toner particles.

3. Toner Property

(1) Fluorescent X-Ray Analyzing Measurement

The toner according to the present invention is characterized in that, assuming the Si strength as I_{Si}, the Ti strength as I_{Ti} and the Fe strength as I_{Fe} when the toner is subjected to the fluorescent X-ray analyzing measurement, these strengths satisfy the following relationships (1) and (2).
9.0×10⁻³≦I_{Si}/I_{Fe}≦1.0×10² (1)
6.0×10⁻³≦I_{Ti}/I_{Fe}≦8.0×10⁻³ (2)

Here, the Si strength (I_{Si}) obtained by the fluorescent X-ray analyzing is a value which corresponds to the content of the silica which are added to the toner for assuring the fluidity of the toner. In general, the addition of silica exhibits a tendency that when the Si strength (I_{Si}) is increased, the fluidity of the toner is improved, while when the Si strength (I_{Si}) is decreased, the fluidity of the toner may be worsened.

Further, the Ti strength (I_{Ti}) obtained by the fluorescent X-ray analyzing is a value which corresponds to the content of titanium oxide which is added with to the toner for assuring the grinding property of the photoconductor. In general, the addition of titanium exhibits a tendency that when the Ti strength (I_{Ti}) is increased, the toner adhesion to the photoconductor becomes more difficult to occur, while when the Ti strength (I_{Ti}) is decreased, the toner adhesion to the photoconductor becomes easier to occur.

Further, the Fe strength (I_{Fe}) obtained by the fluorescent X-ray analyzing is a value which corresponds to the content of the magnetic powder which is contained in the toner for assuring the magnetic property of the toner. In general, the inclusion of iron exhibits a tendency that when the Fe strength (I_{Fe}) is increased, a thin layer forming state of the developing sleeve is improved, while when the Fe strength (I_{Fe}) is decreased, the thin layer forming state of the developing sleeve is worsened.

Here, the Si strength, the Ti strength and the Fe strength which are obtained by the fluorescent X-ray analyzing are respectively related to each other and, when the relationships (1) and (2) are satisfied, irrespective of a change brought about by a lapse of time or an environmental change, it may be possible to form and maintain the thin toner layer having a uniform thickness on the developing sleeve and, at the same time, to maintain the surface of the photoconductor in the clean conditions. Accordingly, it may be possible to form an image having a high quality for a long time period.

Here, from a viewpoint of further improving the fluidity of the toner, the grinding property of the photoconductor or the like, it may be more preferable that the strengths satisfy the following relationships (1′) and (2′).
9.0×10⁻³≦I_{Si}/I_{Fe}≦9.0×10⁻³ (1′)
6.2×10⁻³≦I_{Ti}/I_{Fe}≦7.8×10⁻³ (2′)

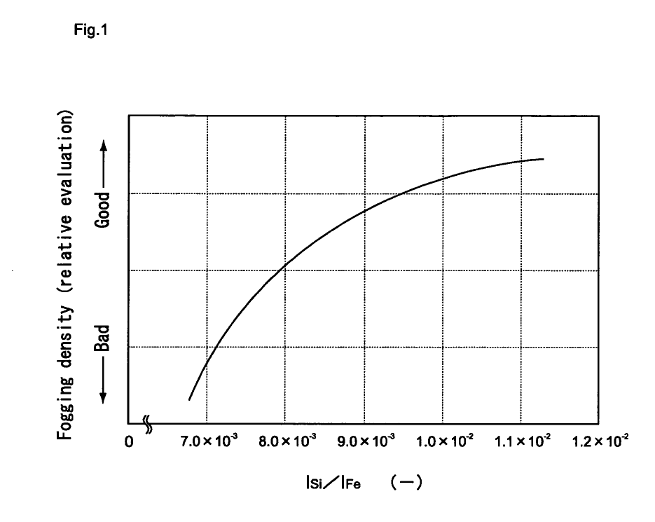

Next, in conjunction with FIG. 1 to FIG. 4, the reason that the Si strength (I_{Si}), the Ti strength (I_{Ti}) and the Fe strength (I_{Fe}) calculated from the fluorescent X-ray analyzing measurement satisfy the relationships (1) and (2), is explained in further detail.

First of all, FIG. 1 is a view showing the relationship between the fluorescent X-ray strength ratio (I_{Si}/I_{Fe}) and the fogging density (relative value) of the toner. The fluorescent X-ray strength ratio (I_{Si}/I_{Fe}) is taken on the axis of abscissa and the fogging density (relative value) is taken on the axis of ordinate.

As may be understood from FIG. 1, there exists a tendency that the higher the fluorescent X-ray strength ratio (I_{Si}/I_{Fe}) becomes, the more the fogging density is improved. That is, it may be understood that, the more the content of the silica which corresponds to the Si strength is increased, the more the fluidity of the toner is enhanced and hence, the fogging density is improved. Accordingly, in view of the relationship between the fluorescent X-ray strength ratio (I_{Si}/I_{Fe}) and the fogging density, it may be preferable to set the fluorescent X-ray strength ratio (I_{Si}/I_{Fe}) to a value equal to or more than 9.0×10⁻³, and it may be more preferable to set the fluorescent X-ray strength ratio (I_{Si}/I_{Fe}) to a value equal to or more than 9.2×10⁻³.

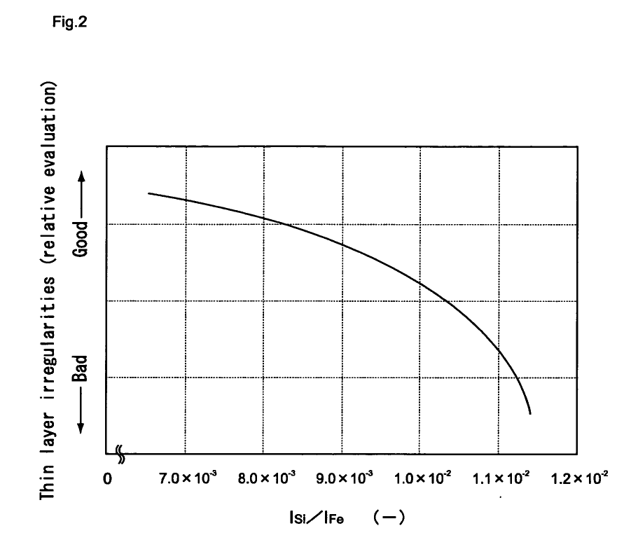

Further, FIG. 2 is a view showing the relationship between the fluorescent X-ray strength ratio (I_{Si}/I_{Fe}) and the thin layer irregularities evaluation (relative value) of the toner. The fluorescent X-ray strength ratio (I_{Si}/I_{Fe}) is taken on the axis of abscissa and the thin layer irregularity (relative value) is taken on the axis of ordinate.

As may be understood from FIG. 2, there exists a tendency that the lower the fluorescent X-ray strength ratio (I_{Si}/I_{Fe}) becomes, the more the thin layer irregularities are decreased. That is, it may be understood that, the more the content of the magnetic powder which corresponds to the Fe strength is increased, the more the charging property of the toner particles is enhanced and hence, the thin layer irregularities could be decreased. Accordingly, in view of the relationship between the fluorescent X-ray strength ratio (I_{Si}/I_{Fe}) and the thin layer irregularity evaluation, it may be preferable to set the fluorescent X-ray strength ratio (I_{Si}/I_{Fe}) to a value equal to or less than 1.0×10⁻², and it may be more preferable to set the fluorescent X-ray strength ratio (I_{Si}/I_{Fe}) to a value equal to or less than 9.8×10⁻³.

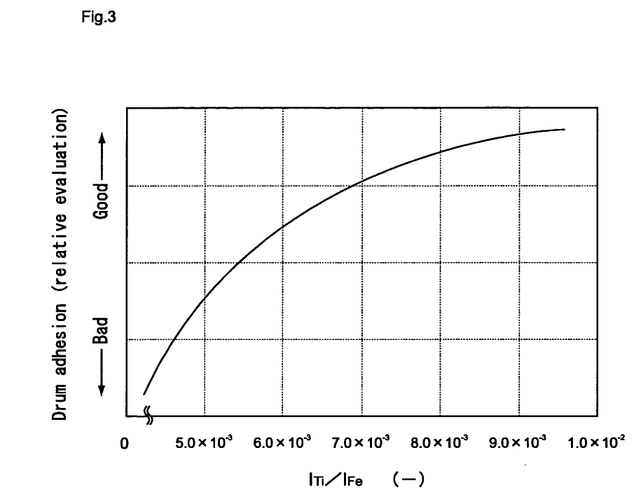

Further, FIG. 3 is a view showing the relationship between the fluorescent X-ray strength ratio (I_{Ti}/I_{Fe}) and the drum adhesion evaluation (relative value) of the toner. The fluorescent X-ray strength ratio (I_{Ti}/I_{Fe}) is taken on the axis of abscissa and the drum adhesion evaluation (relative value) is taken on the axis of ordinate.

As may be understood from FIG. 3, there exists a tendency that the higher the fluorescent X-ray strength ratio (I_{Ti}/I_{Fe}), the more the drum adhesion is improved. That is, it may be understood that, the more the content of the titanium oxide which corresponds to the Ti strength is increased, the more grinding property to the surface of the photoconductor is enhanced and hence, the drum adhesion is decreased. Accordingly, with respect to the drum adhesion evaluation, it may be preferable to set the fluorescent X-ray strength ratio (I_{Ti}/I_{Fe}) to a value equal to or more than 6.0×10⁻³, and it may be more preferable to set the fluorescent X-ray strength ratio (I_{Ti}/I_{Fe}) to a value equal to or more than 6.2×10⁻³.

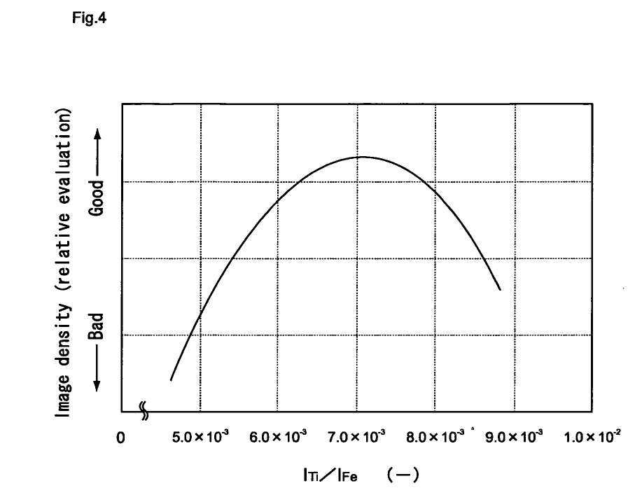

Further, FIG. 4 is a view showing the relationship between the fluorescent X-ray strength ratio (I_{Ti}/I_{Fe}) and the image density evaluation (relative value) of the toner. The fluorescent X-ray strength ratio (I_{Ti}/I_{Fe}) is taken on the axis of abscissa and the image density evaluation (relative value) is taken on the axis of ordinate.

As can be understood from FIG. 4, when the fluorescent X-ray strength ratio (I_{Ti}/I_{Fe}) is set to a value which falls within a predetermined range, the image density is improved. It may be understood that, the more the content of titanium oxide which corresponds to the Ti strength is increased, the more the grinding property with respect to the surface of the photoconductor is enhanced and hence, the image density is improved, while the more the content of the magnetic powder which corresponds to the Fe strength is increased, the more the charging property of the toner particles are changed abnormally and hence, the image density is worsened. Accordingly, in evaluating the image density with respect to the fluorescent X-ray strength ratio (I_{Ti}/I_{Fe}), the image density is improved only within a predetermined range.

Accordingly, in view of the relationship between the fluorescent X-ray strength ratio (I_{Ti}/I_{Fe}) and the image density evaluation, it may be preferable to set the fluorescent X-ray strength ratio (I_{Ti}/I_{Fe}) to a value equal to or more than 6.0×10⁻³ and equal to or less than 8.0×10⁻³, and it may be more preferable to set the fluorescent X-ray strength ratio (I_{Ti}/I_{Fe}) to a value equal to or more than 6.2×10⁻³ and equal to or less than 7.8×10⁻³

(2) Specific Resistance

Further, it may be preferable to set the specific resistance of the toner (volume resistivity) to a value which falls within a range from 1×10¹³ to 1×10¹⁶ Ω·cm.

The reason is that when the specific resistance of the toner assumes a value less than 1×10¹³ Ω·cm, there may arise a case that the leaking of an electric current occurs between the developing sleeve and an image carrying body, while when the specific resistance of the toner exceeds 1×10¹⁶ Ω·cm, there may arise a case that an electrostatic adhesive force between the carrier and the toner on the magnetic sleeve is increased and hence, the toner does not sufficiently jump whereby a ghost phenomenon occurs.

Here, it may be possible to measure the specific resistance of the toner by using a method described in the embodiment 1 which will be described later.

(3) Volume Average Particle Size

Further, although the volume average particle size of the toner particles is not particularly limited, usually, it may be preferable to set the volume average particle size to a value which falls within a range from 3 to 20 μm.

The reason is that when the volume average particle size of the toner becomes less than 3 μm, there may arise a case that the stable manufacture of the toner becomes difficult, while when the volume average particle size of the toner exceeds 20 μm, there may arise a case that the acquisition of the high-quality image becomes difficult.

Accordingly, it may be more preferable to set the volume average particle size of the toner particle to a value which falls within a range from 4 to 15 μm.

Here, the volume average particle size of the toner is a value in a state that the additive agent dose not cover the toner and, it may be possible to measure the volume average particle size of the toner using the laser diffraction grating particle size measuring device LA-500 made by Horiba Seisakusho company LTD, for example.

(4) Manufacturing Method

Further, the manufacturing method of the toner is preferably performed as follows. First of all, the above-mentioned binder resin, the wax, the coloring agent and other additive agents when necessary are premixed using a known method and, thereafter, melting and kneading treatment is performed so as to prepare a toner-use resin composition. Then, the obtained toner-use resin composition is pulverized using a known method and, thereafter, the classifying treatment is performed to obtain the toner particles.

Here, it may be preferable to perform the premixing treatment using, for example, a Henschel mixer, a ball mill, a super mixer, a dry blender or the like.

Further, it may be preferable to carry out the melting and kneading treatment using, for example, a twin-screw extruder, a one-screw extruder or the like. Further, it may be preferable to perform the pulverizing treatment using, for example, an airflow type pulverizer. Still further, it may be preferable to perform the classifying treatment using, for example, an air classifying machine or the like.

The toner which is obtained in this manner is mixed with the above-mentioned additive agents in a known method thus forming the toner which contains the additive agents.

Here, as a method for mixing, the additive agents are mixed with the toner using the Henschel mixer or the like.

4. Developing Unit

(1) Basic Constitution

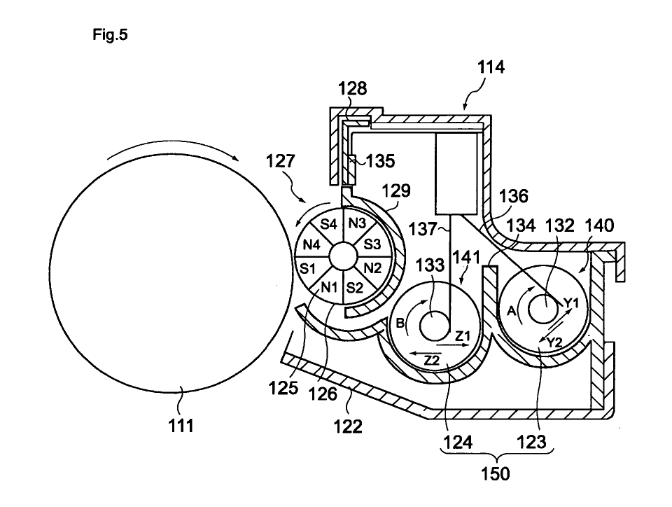

Further, as a developing unit which is used in the present invention, as shown in FIG. 5, as an example, it may be possible to use a developing unit 114 which includes a developing container 122 for accommodating the developer, a developer carrying body 127 for maintaining the developer and conveying the developer to a developing region, a developer layer thickness restricting member 128 for restricting a layer thickness of the developer, helical pressure springs 150 which are rotated with respect to predetermined rotation axes as centers of rotation and convey the developer in the rotation axis direction.

Here, the helical pressure springs 150 are constituted of a first spiral member 123 and a second spiral member 124 which constitute conveying means for conveying the toner particles in a predetermined direction and a toner removing member 136 for removing the toner particles which are adhered to the spiral members 123, 124.

To be more specific, the helical pressure springs 150 are provided with the first spiral member 123 which is formed of a shaft 132 which constitutes a rotatable first shaft and is arranged in the inside of an agitating chamber 140 for agitating the toner particles and spiral-like blades 130 (not shown in the drawing) which are mounted on a peripheral surface of the shaft 132, wherein by rotating the first spiral member 123 in the direction indicated by an arrow A in FIG. 5, the toner is conveyed in the longitudinal direction of the shaft 132.

Further, the helical pressure springs 150 are provided with the second spiral member 124 which is formed of a shaft 133 which constitutes a rotatable second shaft and is arranged in substantially parallel to the shaft 132 and spiral-like blades (not shown in the drawing) which are mounted on a peripheral surface of the shaft 133, wherein by rotating the second spiral member 124 in the direction indicated by an arrow B in FIG. 5, the toner is conveyed in the longitudinal direction of the shaft 133.

Here, the first spiral member 123 and the second spiral member 124 are arranged in approximately parallel to each other. Further, between the first spiral member 123 and the second spiral member 124, a partition member 134, which divides the agitating chamber 140 and a developing chamber 141 in a state that the agitating chamber 140 and the developing chamber 141 are communicable with each other, is provided. Accordingly, it may be possible to convey the toner while agitating the toner in a circulating manner.

Further, as shown in FIG. 5, the developing unit 114 includes a fixed magnet roller 125 which is arranged on a drum opening side of the developing container 122 and has a plurality of magnetic poles, and the developer carrying body 127 which includes a non-magnetic developing sleeve 126 which accommodates the fixed magnet roller 125 in the inside thereof and is pivotally and rotatably supported for introducing the accommodated toner to the surface of the photoconductor 111.

Further, the developing unit 114 includes a developer layer thickness restricting member 128 which is formed of a plate-like magnetic body and is arranged in the vicinity of the developing sleeve 126 and extends downwardly toward an upper surface of the developing sleeve 126 and a magnetic body sealing member 129 which is arranged at an end portion of the developing sleeve 126 in the longitudinal direction.

Further, a toner replenishing hole (not shown in the drawing) is opened above the first spiral member 123 so as to allow the supply of the toner therethrough. That is, the supplied toner is carried in the inside of the developing chamber 141 by using the first spiral member 123. The toner which is introduced into the developing chamber 141 is introduced into the developing sleeve 126 by the second spiral member 124. The toner which is introduced into the developing sleeve 126 is carried on the developing sleeve 126 by a magnetic force of the fixed magnet roller 125 and, a thickness of the toner is restricted by the developer layer thickness restricting member 128 which is arranged in the vicinity of the developing sleeve 126.

Next, the toner which is carried on the developing sleeve 126 is guided to a developing position, that is, a surface of the photoconductor 111, by the developer carrying body 127 and, due to a contact between the photoconductor 111 and a printing paper, an image is transferred and formed on the printing paper.

(2) Developing Sleeve

Further, the toner according to the present invention is characterized in that a surface average gradient (Δa) of the developing sleeve is set to a value which falls within a range from 0.1 to 0.25 rad.

The reason is that, due to such a constitution, irrespective of a change brought about by a lapse of time or an environmental change, it may be possible to form and maintain the thin toner layer having a further uniform thickness on the developing sleeve.

That is, the reason is that, either when the surface average gradient (Δa) of the developing sleeve is set to a value smaller than 0.1 rad or when the surface average gradient (Δa) of the developing sleeve is set to a value larger than 0.25 rad, with respect to the toner particles having average degrees of circularity which respectively fall within predetermined ranges, when a change brought about by a lapse of time or an environmental change occurs, there may arise a case that it is difficult to form and maintain the thin toner layer having a further uniform thickness on the developing sleeve.

Accordingly, it may be more preferable that the surface average gradient (Δa) of the developing sleeve is set to a value which falls within a range from 0.12 to 0.23 rad, and it may be further more preferable that the surface average gradient (Δa) of the developing sleeve is set to a value which falls within a range from 0.15 to 0.20 rad.

Further, it may be preferable to set a ten-point average roughness (Rz) of the developing sleeve which is measured in accordance with JIS B0601 to a value which falls within a range from 3.5 to 5.0 μm.

The reason is that, due to such a constitution, irrespective of a change brought about by a lapse of time or an environmental change, it may be possible to form and maintain the thin toner layer having a further uniform thickness on the developing sleeve.

That is, either when the ten-point average roughness (Rz) is set to a value less than 3.5 μm or when the ten-point average roughness (Rz) is set to a value more than 5.0 μm, with respect to the toner particles having the average degrees of circularity which fall within predetermined ranges respectively, when a change brought about by a lapse of time or an environmental change occurs, there may arise a case that it is difficult to form and maintain the thin toner layer having a further uniform thickness on the developing sleeve.

Accordingly, it may be more preferable that the ten-point average roughness (Rz) of the developing sleeve which is measured in accordance with JIS B0601 is set to a value which falls within a range from 3.8 to 4.8 μm.

Further, it may be preferable to set an average interval (Sm) of the developing sleeve which is measured in accordance with JIS B0601 to a value which falls within a range from 50 to 70 μm.

The reason is that, due to such a constitution, irrespective of a change brought about by a lapse of time or an environmental change, it may be possible to form and maintain the thin toner layer having a further uniform thickness on the developing sleeve.

That is, either when the average interval (Sm) is set to a value less than 50 μm or when the average interval (Sm) is set to a value more than 70 μm, with respect to the toner particles having the average degrees of circularity which fall within predetermined ranges respectively, when a change brought about by a lapse of time or an environmental change occurs, there may arise a case that it is difficult to form and maintain the thin toner layer having a further uniform thickness on the developing sleeve.

Accordingly, it may be more preferable to set an average interval (Sm) of the developing sleeve which is measured in accordance with JIS B0601 to a value which falls within a range from 55 to 65 μm.

5. Amorphous Silicon Photoconductor

Although the constitution of the amorphous silicon photoconductor is not particularly limited, it may be preferable to adopt the constitution in which, for example, an amorphous silicon photoconductor layer is formed over a conductive base pipe formed of aluminum or the like, and a surface layer formed of amorphous silicon carbide or the like is further stacked on the amorphous silicon photoconductor layer thus enhancing the hardness of the surface of the photoconductor.

Further, although the amorphous silicon photoconductor is uniformly charged with a potential which falls within a range from 250 to 480V, this charging potential is characterized by that the charging potential is lower than that of other photoconductor such as an organic photoconductor.

### Second Embodiment

A second embodiment is directed to an image forming method in which a toner for electrostatic latent image development which is externally added with at least silica and titanium oxide to toner particles containing a magnetic powder is applied to a magnetic jumping method which uses an electrophotographic photoconductor and a developing sleeve arranged close to the electrophotographic photoconductor, wherein as the toner for electrostatic latent image development, the image forming method uses a toner for electrostatic latent image development which satisfies the following relationships (1) and (2) and sets Si strength of the toner as I_{Si}, Ti strength of the toner as I_{Ti} and Fe strength of the toner as I_{Fe} when these strengths are measured by using a fluorescent X-ray analyzing device, and sets an average degree of circularity of the toner particles to a value which falls within a range from 0.940 to 0.960 and a surface average gradient (Δa) of the developing sleeve to a value which falls within a range from 0.1 to 0.25 rad.
9.0×10⁻³≦I_{Si}/I_{Fe}≦1.0×10⁻² (1)
6.0×10⁻³≦I_{Ti}/I_{Fe}≦8.0×10⁻³ (2)

Hereinafter, the explanation of the contents of the invention which have been already described in the first embodiment is omitted. That is, in this second embodiment, the explanation will be made by mainly focusing on the constitution of the image forming apparatus which uses the above-mentioned toner for electrostatic latent image development and the image forming method.

1. Image Forming Apparatus

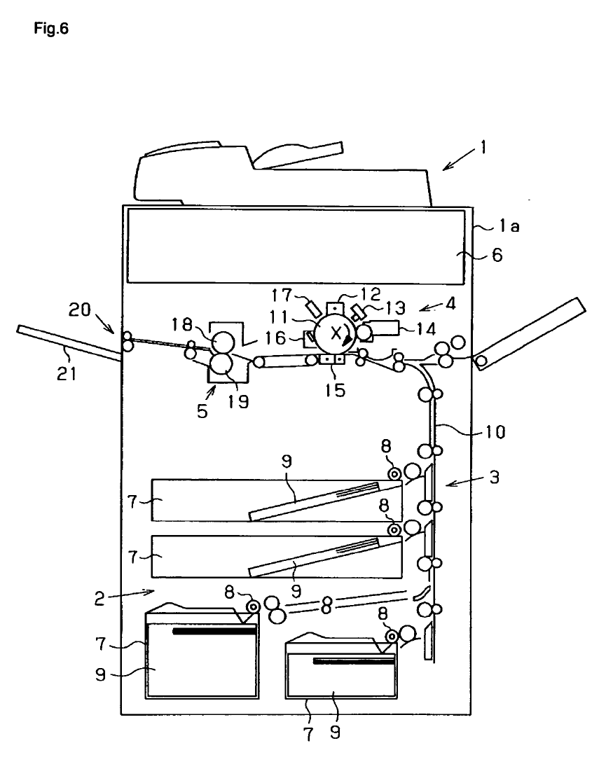

In performing the image forming method according to the second embodiment, the image forming method is preferably applicable to an image forming apparatus 1 shown in FIG. 6.

Here, FIG. 6 is a schematic view showing the whole constitution of the image forming apparatus. The image forming apparatus 1 includes a paper feeding part 2 which is arranged in a lower portion of an image forming apparatus body 1a, a paper conveying part 3 which is arranged on a side of and above the paper feeding part 2, an image forming part 4 which is arranged above the paper conveying part 3, a fixing part 5 which is arranged at a position closer to a discharge side than the image forming part 4, and an image reading part 6 which is arranged above the image forming part 4 and the fixing part 5.

Further, the paper feeding part 2 includes a plurality of (four in this embodiment) paper feeding cassettes 7 which store papers 9. Due to a rotational operation of a paper feeding roller 8, the papers 9 are fed to the paper conveying part 3 from the paper feeding cassette 7 which is selected from the plurality of paper feeding cassettes 7 so as to surely feed the papers 9 one by one to the paper conveying part 3. Here, these four paper feeding cassettes 7 are detachably mounted on the image forming apparatus body 1a.

Further, the paper 9 which is fed to the paper conveying part 3 is conveyed toward the image forming part 4 via a paper feeding path 10. The image forming part 4 is provided for forming a predetermined toner image on the paper 9 using an electrophotographic process. The image forming part 4 includes a photoconductor 11 which constitutes an image carrying body and is pivotally supported in a state that the photoconductor 11 can be rotated in the predetermined direction (in the direction indicated by an arrow X in the drawing) and also includes a charging device 12, an exposure device 13, a developing unit 14, a transfer device 15, a cleaning device 16 and a charge elimination device 17 which are arranged in the periphery of the photoconductor 11 and along the rotational direction of the photoconductor 11.

Further, the charging device 12 includes charging wires to which a high voltage is applied. By applying a predetermined potential to a surface of the photoconductor 11 by making use of a corona discharge generated by the charging wires, the surface of the photoconductor 11 is uniformly charged. Then, in the exposure device 13, light based on an image data of an original which is read by the image reading part 6 is radiated to the photoconductor 11. Accordingly, the surface potential of the photoconductor 11 is selectively attenuated and an electrostatic latent image is formed on the surface of the photoconductor 11. Next, the toner is adhered to the electrostatic latent image by using the developing unit 14, the toner image is formed on the surface of the photoconductor 11 and, thereafter, the toner image on the surface of the photoconductor 11 is transferred to the paper 9 which is supplied between the photoconductor 11 and the transfer device 15 using the transfer device 15.

Further, the paper 9 to which the toner image is transferred is conveyed toward the fixing part 5 from the image forming part 4. The fixing part 5 is arranged on a downstream side of the image forming part 4 in the paper conveying direction. The paper 9 to which the toner image is transferred in the image forming part 4 is sandwiched between a heating roller 18 and a pressing roller 19 which is brought into pressure contact with the heating roller 18 which are provided in the fixing part 5, wherein the paper 9 is also heated by the heating roller 18 whereby the toner image is fixed to the paper 9. Next, the paper 9 on which the image is formed through steps of the image forming part 4 and the fixing part 5 is discharged to a discharge tray 21 by a pair of discharge rollers 20. On the other hand, after the toner image is transferred, the toner remained on the surface of the photoconductor 11 is removed by using a cleaning device 16.

Here, a residual charge on the surface of the photoconductor 11 is removed by using a charge elimination device 17 and the photoconductor 11 is charged again by using the charging device 12. Hereinafter, the image is formed by using the same steps as the first embodiment.

2. Toner for Electrostatic Latent Image Development

Any toner for electrostatic latent image development may be preferably used as the toner for electrostatic latent image development for the second embodiment so long as the toner allows the Si strength, the Ti strength and the Fe strength to satisfy the predetermined relationships and the toner has the predetermined average degree of circularity. Here, with respect to the details of the toner for electrostatic latent image development for the second embodiment, the toner may have the substantially same content as the toner for electrostatic latent image development for the first embodiment.

### EXAMPLE

Hereinafter, the present invention is further explained in detail in conjunction with the examples. Here, it is needless to say that the following explanation of the present invention is provided only for an illustration purpose and the scope of the present invention is not limited to the following explanation unless otherwise specified.

### Example 1

1. Preparation of Developing Sleeve

Bead blasting treatment is applied to a sleeve having a length of 300 mm which is made of SUS316 under predetermined blasting treatment conditions (a bead size, a bead collision speed) thus preparing a developing sleeve (S1) as shown in Table 1.

Here, a surface average gradient (Δa) of the developing sleeve is measured in accordance with JIS B0601. That is, the surface average gradient (Δa) is measured by the three-dimensional interference microscope WYKO NT1100 type (made by Veeco Instruments) under the following condition.

magnification of measuring lens: 10 times

measuring mode: VSL

measuring size: 2438×482 μm

sampling: 820.96 nm

The ten-point average roughness (Rz) and the average interval (Sm) of the developing sleeve are measured in accordance with JIS B0601 by using a surface texture measuring instrument (SURFCOM 1400D: made by Tokyo Seimitsu Co., Ltd.).

2. Formation of Toner for Electrostatic Latent Image Development

(1) Formation of Toner Particles

First of all, a plurality of polyester resins is used as binder resins and a magnetic powder or the like is mixed into the binder resins and, thereafter, these resins and a magnetic powder are melted and kneaded.

That is, 100 parts by weight of a polyester resin (an alcohol component: an bisphenol-A propionic oxide additive, an acid component: a terephthalic acid, Tg: 60° C., a softening point: 150° C., an acid value: 7.0, a gel fraction: 30%), 76 parts by weight of a magnetic powder body (product name MTSB-905, made by Toda Kogyo Corp.), 3 parts by weight of CCA as a charge control component (product name BONTRON No. 1, made by Orient Chemical Industries, Ltd.), 8 parts by weight of a charge control resin (quaternary ammonium salt addition styrene-acrylic copolymer: FCA196 made by Fujikura Kasei Co., Ltd.), 3 parts by weight of ester wax (product name: WEP.5, made by NOF CORPORATION) as wax are mixed by using a Henschell mixer.

Next, the compositions are further mixed and kneaded by using a twin screw extruder (cylinder preset temperature: 100° C.) and, thereafter, the compositions are roughly pulverized by using a feather mill. Then, the mixed material is finely pulverized by using a turbo mill and is classified by using an air classifier whereby toner particles having an average particle size of 8.0 μm are obtained.

(2) Addition of Inorganic Particles

To 100 parts by weight of the obtained toner particles, 0.8 parts by weight of silica (product name: RA200HS, made by NIPPON AEROSIL CO., LTD.) and 1.0 part by weight of titanium oxide (product name: EC100T1, made by Titan Kogyo) are mixed by using a Henschel mixer thus producing a magnetic toner 1.

3. Evaluation of Toner for Electrostatic Latent Image Development

The image density, the initial image characteristic, the durability and the fogging characteristic of the obtained magnetic toner 1 are respectively evaluated by using a page printer made by KYOCERA Corporation (modified LS-9500) on which an amorphous silicon photoconductor (a-Si) is mounted. The obtained evaluation results are shown in table 1 and table 2.

(1) Fluorescent X-Ray Measurement

In a state that the inorganic particles are not yet added to the toner particles, Si strength (I_{Si}), Ti strength (I_{Ti}) and Fe strength (I_{Fe}) of the toner particles are measured by using a fluorescent X-ray analyzing device. That is, by using a briquetting press (BRE-32: made by Maekawa Testing Machine Mfg. Co., LTD.), a pressurizing force of 20 MPa is applied to 5 g of toner particles for 3 seconds thus making round-shaped pellets (diameter: 40 mm, thickness: 5 mm). Thereafter, by using a fluorescent X-ray analyzing device RIX made by Rigaku Corporation, fluorescent X-ray peak intensities (kcps) attributed to Si or the like of the pellets are measured. (voltage: 50 kV, current: 30 mA, X-ray tube: Rh)

(2) Measurement of Average Degree of Circularity

In a state that the inorganic particles are not yet added to the toner particles, the average degree of circularity of the toner particles is measured. That is, the average degree of circularity of the toner particles is measured by using FPIA-2100 made by SYSMEX CORPORATION. Here, the average degree of circularity is a value which is expressed by L2/L1, wherein L1 is a peripheral length of the toner particle and L2 is a circumferential length of a circle having the same projection area (S) as a particle image. Then, the average degree of circularity of the toner particles is calculated by averaging the degree of circularity with respect to the whole toner particles. As a specific measuring method, 10 ml of demineralized water from which solidified impurities or the like are removed in advance is prepared in a container, and the surface-active agent, preferably alkyl benzene sulfonate, is added to the demineralized water as a dispersing agent. Thereafter, 0.02 g of measuring sample is further added and is uniformly dispersed.

(3) Image Characteristics

(3)-1 Image Density

By using a modified page printer made by Kyocera Mita Corporation (ECOSYS LS-9500) on which an amorphous silicon photoconductor is mounted, under a normal condition (20° C., 65% RH), an initial image is obtained by printing an image evaluation pattern.

Next, a solid image density which constitutes an image evaluation pattern printed on the initial image is measured by using a Macbeth reflection density meter (made by GretagMacbeth AG). To be more specific, the density is measured at arbitrary 9 points on a solid portion of a solid image pattern, and the average value of the density is calculated and is used as the image density.

Next, 10,000 sheets are printed under a normal condition (at 20° C., 65% RH) and 100,000 sheets are printed under a low-temperature and low-moisture condition (at 10° C., 20% RH) and, thereafter, the image density is evaluated in the same manner as described above in accordance with the following criteria.

G (good): Image density is equal to or more than 1.300 or more.

F (fair): Image density is equal to or more than 1.200 or more.

B (bad): Image density is less than 1.200.

(3)-2 Fogging Density

By using the obtained magnetic toner 1 as a magnetic monocomponent developer, the image is formed by using a modified page printer made by Kyocera Mita Corporation (ECOSYS LS-9500) on which an amorphous silicon photoconductor is mounted and, thereafter, by using the Macbeth reflection density meter (made by GretagMacbeth AG), the fogging density of portions except for printed portions is evaluated in accordance with the following criteria.

G(good): Fogging density is 0.007 or less.

F(fair): Fogging density is 0.010 or less.

B(bad): Fogging density is over 0.010.

(4) Thin Layer Condition on Developing Sleeve

G(good): A thin layer having a uniform thickness is formed on the developing sleeve and no thickness irregularities of the layer are found.

B(bad): A thin layer condition having non-uniform thickness is formed on the developing sleeve and thickness irregularities of the layer are found.

(5) Inspection of Surface of Photoconductor

G(good): No adherent is found on the surface of the photoconductor.

B(bad): Adherents are found on the surface of the photoconductor.

Here, the developing conditions of the modified LS-9500 image forming apparatus made by Kyocera Mita Corporation are as follows.

[Developing Conditions]

developing method: dry-type mono-component jumping development

circumferential speed of photoconductor drum: 440 mm/sec (80 sheets/min converted into A4 paper)

gap between photoconductor and developing sleeve: 0.30 mm

circumferential speed ratio between developing sleeve and photoconductor: 1.4

blade gap: 0.25 mm

potential of photoconductor: 400 V

bias voltage of developing DC: 300 V

peak-to-peak voltage of developing AC: 1.5 KV

frequency of developing AC: 2.5 KHz

number of magnet roll poles of developing sleeve: 4 poles

magnetic flux density of S1 pole (development pole): 800×10⁻⁴ T

### Examples 2 to 15, Comparison examples 1 to 12

In the same manner as the example 1, predetermined developing sleeves are prepared and, thereafter, toners for an electrostatic latent image development are formed and are evaluated.

Further, with respect to the developing sleeves (S1 to S9) used in the example 2 and the like, as shown in Table 1, the developing sleeves are prepared by changing shot-blasting conditions (bead size, bead collision speed) and by changing a surface average gradient (Δa) of the developing sleeve, a ten-point average roughness (Rz) thereof and an average gap (Sm) which are measured in accordance with JIS B0601.

Further, with respect to the average degree of circularity of the toner particles, pulverization conditions of the turbo mill (a process speed, a blade rotation speed, a number of pass, a static pressure) are changed and adjusted, and magnetic toners 2, 3, 10 and 11 are formed.

Further, by changing an addition quantity of the magnetic powder, magnetic toners 4, 5, 12 and 13 are formed.

Further, by changing an addition quantity of silica and titanium oxide, magnetic toners 6 to 9, and toners 14 to 19 are formed.

TABLE 1

| | Measurement result | | |
|---|---|---|---|
| Sleeve No. | Δa (-) | Rz (μm) | Sm (μm) |
| S1 | 0.150 | 4.5 | 60 |
| S2 | 0.080 | 4.5 | 60 |
| S3 | 0.100 | 4.5 | 60 |
| S4 | 0.250 | 4.5 | 60 |
| S5 | 0.270 | 4.5 | 60 |
| S6 | 0.150 | 3.4 | 48 |
| S7 | 0.150 | 3.5 | 50 |
| S8 | 0.150 | 5.0 | 70 |
| S9 | 0.150 | 5.1 | 72 |

TABLE 2

| | | adding quantity of | | | | | | | |
|---|---|---|---|---|---|---|---|---|---|
| | degree of | additive agent(wt. %) | | | | | | | |
| toner | circularity | magnetic | | titanium | fluorescent X-ray intensity | | | | |
| No. | (—) | powder | silica | oxide | I_{Si} | I_{Ti} | I_{Fe} | I_{Si/}I_{Fe} | I_{Ti/}I_{Fe} |
| 1 | 0.950 | 40 | 0.8 | 1.0 | 13.5 | 9.9 | 1400 | 9.6E−03 | 7.1E−03 |
| 2 | 0.940 | 40 | 0.8 | 1.0 | 13.2 | 9.6 | 1310 | 1.0E−02 | 7.3E−03 |
| 3 | 0.960 | 40 | 0.8 | 1.0 | 13.7 | 10.0 | 1460 | 9.4E−03 | 6.8E−03 |
| 4 | 0.950 | 30 | 0.8 | 1.0 | 12.7 | 9.7 | 1210 | 1.0E−02 | 8.0E−03 |
| 5 | 0.950 | 50 | 0.8 | 1.0 | 13.7 | 9.7 | 1520 | 9.0E−03 | 6.4E−03 |
| 6 | 0.950 | 40 | 0.6 | 1.0 | 12.6 | 9.9 | 1400 | 9.0E−03 | 7.1E−03 |
| 7 | 0.950 | 40 | 1.0 | 1.0 | 14.3 | 9.9 | 1400 | 1.0E−02 | 7.1E−03 |
| 8 | 0.950 | 40 | 0.8 | 0.8 | 13.5 | 8.4 | 1400 | 9.6E−03 | 6.0E−03 |
| 9 | 0.950 | 40 | 0.8 | 1.2 | 13.5 | 11.0 | 1400 | 9.6E−03 | 7.9E−03 |
| 10 | 0.935 | 40 | 0.8 | 1.0 | 13.0 | 9.5 | 1260 | 1.0E−02 | 7.5E−03 |
| 11 | 0.965 | 40 | 0.8 | 1.0 | 13.9 | 10.0 | 1470 | 9.5E−03 | 6.8E−03 |
| 12 | 0.950 | 28 | 0.8 | 1.0 | 12.6 | 9.6 | 1190 | 1.1E−02 | 8.1E−03 |
| 13 | 0.950 | 52 | 0.8 | 1.0 | 13.8 | 9.2 | 1550 | 8.9E−03 | 5.9E−03 |
| 14 | 0.950 | 40 | 0.5 | 1.0 | 12.4 | 9.9 | 1400 | 8.9E−03 | 7.1E−03 |
| 15 | 0.950 | 40 | 1.1 | 1.0 | 14.7 | 9.9 | 1400 | 1.1E−02 | 7.1E−03 |
| 16 | 0.950 | 40 | 0.8 | 0.7 | 13.5 | 8.2 | 1400 | 9.6E−03 | 5.9E−03 |
| 17 | 0.950 | 40 | 0.8 | 1.4 | 13.5 | 11.4 | 1400 | 9.6E−03 | 8.1E−03 |
| 18 | 0.950 | 40 | 0.3 | 0.5 | 6.5 | 4.9 | 1400 | 4.6E−03 | 3.5E−03 |
| 19 | 0.950 | 40 | 1.3 | 1.6 | 18.0 | 13.9 | 1400 | 1.3E−02 | 9.9E−03 |

TABLE 3

| | | | | | | | after printing 10,000 | | | |
|---|---|---|---|---|---|---|---|---|---|---|
| | mag- | | initial stage | | | | sheets at 10° C./15% RH | | | |
| | netic | | image density | | fogging density | | image density | | fogging density | |
| | toner | sleeve | measurement | | measurement | | measurement | | measurement | |
| | No. | No. | value | evaluation | value | evaluation | value | evaluation | value | evaluation |
| ex 1 | 1 | S1 | 1.390 | G | 0.000 | G | 1.382 | G | 0.002 | G |
| ex 2 | 1 | S3 | 1.388 | G | 0.000 | G | 1.377 | G | 0.002 | G |
| ex 3 | 1 | S4 | 1.391 | G | 0.000 | G | 1.376 | G | 0.003 | G |
| ex 4 | 1 | S7 | 1.359 | G | 0.000 | G | 1.349 | G | 0.002 | G |
| ex 5 | 1 | S8 | 1.401 | G | 0.002 | G | 1.400 | G | 0.004 | G |
| ex 6 | 2 | S1 | 1.320 | G | 0.001 | G | 1.265 | F | 0.005 | G |
| ex 7 | 3 | S1 | 1.401 | G | 0.003 | G | 1.376 | G | 0.009 | F |
| ex 8 | 4 | S1 | 1.382 | G | 0.004 | G | 1.288 | F | 0.007 | G |
| ex 9 | 5 | S1 | 1.321 | G | 0.001 | G | 1.248 | F | 0.002 | G |
| ex 10 | 6 | S1 | 1.333 | G | 0.003 | G | 1.267 | F | 0.004 | G |
| ex 11 | 7 | S1 | 1.389 | G | 0.004 | G | 1.369 | G | 0.006 | G |
| ex 12 | 8 | S1 | 1.345 | G | 0.004 | G | 1.289 | F | 0.005 | G |
| ex 13 | 9 | S1 | 1.326 | G | 0.003 | G | 1.301 | G | 0.005 | G |
| ex 14 | 1 | S6 | 1.342 | G | 0.001 | G | 1.333 | G | 0.003 | G |
| ex 15 | 1 | S9 | 1.403 | G | 0.002 | G | 1.402 | G | 0.004 | G |

| | after printing 10,000 | | | | | | | |
|---|---|---|---|---|---|---|---|---|
| | sheets at | | | | | | | |
| | 10° C./15% RH | | after printing 100,000 sheets at 20° C./65% RH | | | | | |
| | | drum | image density | | fogging density | | | drum |
| | thin layer | adhesion | measurement | | measurement | | thin layer | adhesion |
| | evaluation | evaluation | value | evaluation | value | evaluation | evaluation | evaluation |
| ex 1 | G | G | 1.324 | G | 0.003 | G | G | G |
| ex 2 | G | G | 1.310 | G | 0.004 | G | G | G |
| ex 3 | G | G | 1.318 | G | 0.006 | G | G | G |
| ex 4 | G | G | 1.277 | F | 0.003 | G | G | G |
| ex 5 | G | G | 1.328 | G | 0.007 | G | G | G |
| ex 6 | G | G | 1.235 | F | 0.007 | G | G | G |
| ex 7 | G | G | 1.351 | G | 0.009 | F | G | G |
| ex 8 | G | G | 1.222 | F | 0.009 | F | G | G |
| ex 9 | G | G | 1.209 | F | 0.006 | G | G | G |
| ex 10 | G | G | 1.212 | F | 0.005 | G | G | G |
| ex 11 | G | G | 1.344 | G | 0.008 | F | G | G |
| ex 12 | G | G | 1.249 | F | 0.007 | G | G | G |
| ex 13 | G | G | 1.291 | F | 0.006 | G | G | G |
| ex 14 | F | G | 1.235 | F | 0.007 | G | F | G |
| ex 15 | G | G | 1.334 | G | 0.006 | G | F | G |

ex: example

TABLE 4

| | | | | | | | after printing 10,000 | | | |
|---|---|---|---|---|---|---|---|---|---|---|
| | mag- | | initial stage | | | | sheets at 10° C./15% RH | | | |
| | netic | | image density | | fogging density | | image density | | fogging density | |
| | toner | sleeve | measurement | | measurement | | measurement | | measurement | |
| | No. | No. | value | evaluation | value | evaluation | value | evaluation | value | evaluation |
| ce 1 | 1 | S2 | 1.388 | G | 0.000 | G | 1.383 | G | 0.003 | G |
| ce 2 | 1 | S5 | 1.389 | G | 0.000 | G | 1.377 | G | 0.002 | G |
| ce 3 | 10 | S1 | 1.310 | G | 0.002 | G | 1.222 | F | 0.003 | G |
| ce 4 | 11 | S1 | 1.405 | G | 0.004 | G | 1.388 | G | 0.005 | G |
| ce 5 | 12 | S1 | 1.326 | G | 0.009 | F | 1.265 | F | 0.015 | B |
| ce 6 | 13 | S1 | 1.191 | B | 0.001 | G | | | | |
| ce 7 | 14 | S1 | 1.312 | G | 0.006 | G | 1.231 | F | 0.009 | F |
| ce 8 | 15 | S1 | 1.388 | G | 0.004 | G | 1.333 | G | 0.006 | G |
| ce 9 | 16 | S1 | 1.356 | G | 0.003 | G | 1.291 | F | 0.004 | G |
| ce 10 | 17 | S1 | 1.377 | G | 0.002 | G | 1.326 | G | 0.003 | G |
| ce 11 | 18 | S1 | 1.321 | G | 0.010 | F | 1.156 | B | 0.020 | B |
| ce 12 | 19 | S1 | 1.362 | G | 0.006 | G | 1.251 | F | 0.012 | B |

| | after printing 10,000 | | | | | | | |
|---|---|---|---|---|---|---|---|---|
| | sheets at | | | | | | | |
| | 10° C./15% RH | | after printing 100,000 sheets at 20° C./65% RH | | | | | |
| | | drum | image density | | fogging density | | | drum |
| | thin layer | adhesion | measurement | | measurement | | thin layer | adhesion |
| | evaluation | evaluation | value | evaluation | value | evaluation | evaluation | evaluation |
| ce 1 | B | G | | | | | | |
| ce 2 | B | G | | | | | | |
| ce 3 | G | G | 1.159 | B | 0.005 | G | G | G |
| ce 4 | B | B | | | | | | |
| ce 5 | B | B | | | | | | |
| ce 6 | | | | | | | | |
| ce 7 | G | G | 1.156 | B | 0.010 | F | B | B |
| ce 8 | B | G | | | | | | |
| ce 9 | G | B | | | | | | |
| ce 10 | B | G | | | | | | |
| ce 11 | B | B | | | | | | |
| ce 12 | B | G | | | | | | |

ce: comparison example

As can be understood from a result shown in Table 3, with respect to the examples 1 to 15, since the developing sleeves having the favorable surface average gradient and the toners having the favorable fluorescent X-ray intensity result are used, images which are favorable in image evaluation are obtained.

Further, as can be understood from the result shown in Table 4, with respect to the comparison example 6, unfavorable images are observed in the image density evaluation at the initial stage. This result may be brought about by the fact that, since the fluorescent X-ray intensity of the toner particles falls below the predetermined range, the content of the magnetic powder is large and hence, the transfer efficiency of the toners to the photoconductor is lowered.

Further, with respect to the comparison examples 1, 2, 4 to 5 and 8 to 12, under the normal condition (at 20° C., 65% RH), unfavorable images are observed in the image evaluation after printing 10,000 sheets.

To be more specific, with respect to the comparison examples 1 and 2, the thin layer thickness irregularities may be brought about by the fact that the surface average gradient of the developing sleeve falls outside of the predetermined range and hence, the transfer efficiency of toner particles to the photoconductor from the developing sleeve is lowered.

Further, with respect to the comparison example 4, the thin layer thickness irregularities may be brought about by the fact that the average degree of circularity of the toner particles exceeds the predetermined range and hence, an excessive amount of toner particles is supplied to the developing sleeve.

Further, with respect to the comparison examples 5 and 8 to 12, the fluorescent X-ray intensity ratio falls outside of the predetermined range and hence, either one of the fluidity of the toner and the developing property of the toner is lowered thus generating an defective image.

To be more specific, with respect to the comparison example 5, the value of (I_{Si}/I_{Fe}) and (I_{Ti}/I_{Fe}) is larger than the value of the predetermined range and hence, a binding force of the developing sleeve with the toner particles under a low temperature and low moisture condition (at 10° C., 20% RH) is lowered thus generating a defective image.

With respect to the comparison example 8, the value of (I_{Si}/I_{Fe}) is larger than the predetermined range and hence, an excessive amount of toner is conveyed and hence, a magnetic controlling force of the developing sleeve is lowered thus generating the thin layer thickness irregularities under a low temperature and low moisture condition (at 10° C., 20% RH).

With respect to the comparison example 9, the value of (I_{Ti}/I_{Fe}) is smaller than the predetermined range and hence, a grinding force of a drum is decreased thus generating adherents on the surface of the drum.

With respect to the comparison example 10, the value of (I_{Ti}/I_{Fe}) is larger than the predetermined range and hence, floating additives are increased and the floating additives become a source of the thin layer irregularities and hence, the thin layer irregularities are generated under a low temperature and low moisture condition (at 10° C., 20% RH).

With respect to the comparison example 11, the value of (I_{Si}/I_{Fe}) and (I_{Ti}/I_{Fe}) is smaller than the predetermined range and hence, the excessive electrostatic charge of the toner is generated and a source of the thin layer irregularities is generated whereby the residual toner is hardly peeled off from the developing sleeve and the thin layer irregularities or the adhesion of residual toners to the drum is generated under a low temperature and low moisture condition (at 10° C., 20% RH)

With respect to the comparison example 12, the value of (I_{Si}/I_{Fe}) and (I_{Ti}/I_{Fe}) are larger than the predetermined range and hence, a binding force of the developing sleeve with the toner particles under a low temperature and low moisture condition (at 10° C., 20% RH) is lowered whereby a defective image is formed.

Further, with respect to the comparison examples 3 and 7, unfavorable images are observed in the image evaluation after printing 100,000 sheets under a low temperature and low moisture condition (at 10° C., 20% RH).

To be more specific, with respect to the comparison example 3, since the average degree of circularity of the toner particles is below the predetermined range, the fluidity of the toner is lowered and hence, the defective image density is generated.

Further, with respect to the comparison example 7, the fluorescent X-ray intensity ratio of (I_{Si}/I_{Fe}) is below the predetermined range and hence, the fluidity of the toner and the developing property of the toner are lowered whereby unfavorable images are generated.

What we claim is:

1. A toner for electrostatic latent image development which is used for an image forming apparatus comprising an electrophotographic photoconductor and a developing sleeve which is arranged close to the electrophotographic photoconductor, the toner being externally added with at least silica and titanium oxide to toner particles containing a magnetic powder, wherein
assuming Si strength of the toner as I_{Si}, Ti strength of the toner as I_{Ti} and Fe strength of the toner as I_{Fe}, when I_{Si}, I_{Ti} and I_{Fe} are measured by using a fluorescent X-ray analyzing device, the following relationships (1) and (2) are satisfied, an average degree of circularity of the toner particles is set to a value which falls within a range from about 0.940 to 0.960, and a surface average gradient of the developing sleeve (Δa) is set to a value which falls within a range from about 0.1 to 0.25 rad.
9.0×10⁻³≦I_{Si}/I_{Fe}≦1.0×10⁻² (1)
6.0×10⁻³≦I_{Ti}/I_{Fe}≦8.0×10⁻³ (2)

2. The toner for electrostatic latent image development according to claim 1, wherein a content of the magnetic powder with respect to the total quantity of the toner particles is set to a value which falls within a range from about 30 to 50 weight %.

3. The toner for electrostatic latent image development according to claim 1, wherein a portion of the magnetic powder is exposed on surfaces of the toner particles.

4. The toner for electrostatic latent image development according to claim 1, wherein a ten-point average roughness (Rz) of the developing sleeve which is measured in accordance with JIS B0601 is set to a value which falls within a range from about 3.5 to 5.0 (μm).

5. The toner for electrostatic latent image development according to claim 1, wherein an average distance (Sm) of the developing sleeve which is measured in accordance with JIS B0601 is set to a value which falls within a range from about 50 to 70 (μm).

6. The toner for electrostatic latent image development according to claim 1, wherein a volume average particle size of the toner particle is set to a value which falls within a range from about 3 to 20 (μm).

7. The toner for electrostatic latent image development according to claim 1, wherein the photoconductor is an amorphous silicon photoconductor.

8. An image forming method in which a toner for electrostatic latent image development which is externally added with at least silica and titanium oxide to toner particles containing a magnetic powder is applied to a magnetic jumping method which uses an electrophotographic photoconductor and a developing sleeve arranged close to the electrophotographic photoconductor, wherein
as the toner for electrostatic latent image development, the toner for electrostatic latent image development which satisfies the following relationships (1) and (2) and sets Si strength of the toner as I_{Si}, Ti strength of the toner as I_{Ti} and Fe strength of the toner as I_{Fe}, when I_{Si}, I_{Ti} and I_{Fe} are measured by using a fluorescent X-ray analyzing device, and sets an average degree of circularity of the toner particles to a value which falls within a range from 0.940 to 0.960 and a surface average gradient of the developing sleeve (Δa) to a value which falls within a range from 0.1 to 0.25 rad is used.
9.0×10⁻³≦I_{Si}/I_{Fe}≦1.0×10⁻² (1)
6.0×10⁻³≦I_{Ti}/I_{Fe}≦8.0×10⁻³ (2)
